(19) United States
(12) Patent Application Publication
(10) Pub. No.: US 2022/0319516 A1
(43) Pub. Date: Oct. 6, 2022

(54) CONVERSATION METHOD, CONVERSATION SYSTEM, CONVERSATION APPARATUS, AND PROGRAM

(71) Applicant: NIPPON TELEGRAPH AND TELEPHONE CORPORATION, Tokyo (JP)

(72) Inventors: Hiroaki SUGIYAMA, Tokyo (JP); Hiromi NARIMATSU, Tokyo (JP); Masahiro MIZUKAMI, Tokyo (JP); Tsunehiro ARIMOTO, Tokyo (JP)

(73) Assignee: NIPPON TELEGRAPH AND TELEPHONE CORPORATION, Tokyo (JP)

(21) Appl. No.: 17/764,154

(22) PCT Filed: Oct. 3, 2019
(86) PCT No.: PCT/JP2019/039145

§ 371 Date: Mar. 25, 2022

(51) Int. Cl. G10L 15/22

(52) U.S. Cl. CPC G10L 15/22

(57) ABSTRACT

An object is to give the user the impression that the system has sufficient dialogue capabilities. A dialogue system (100) has a personality virtually set thereto. A microphone (11) collects a spoken voice of a user (101) and converts it into a voice signal. A voice recognition unit (20) performs voice recognition on the voice signal of the spoken voice of the user (101) to convert the voice signal into a text that represents the content of the user's speech. A speech determination unit (30) determines a text representing the content of a system speech that is based at least on information contained in the most recently input user speech and information set to the personality of the dialogue system. The voice synthesis unit (40) converts the text representing the content of the system speech into a voice signal representing the content of the system speech. A speaker (51) outputs the voice signal representing the content of the system speech.

### TECHNICAL FIELD

The present invention relates to a technique that is applicable to a robot or the like that communicates with a human, with which a computer has dialogue with a human, using a natural language or the like.

### BACKGROUND ART

Dialogue systems in various forms have been put to practical use, such as a dialogue system that recognizes a user's voice speech, generates a response sentence to the speech, synthesizes a voice, and utters the voice using a robot or the like, and a dialogue system that accepts a user's speech made by inputting a text, and generates and displays a response sentence to the speech. In recent years, attention has been focused on a chat dialogue system for chatting, which is different from conventional task-oriented dialogue systems (see Non Patent Literature 1, for example). A task-oriented dialogue is a dialogue that aims to efficiently achieve a task with a different clear goal through a dialogue. Unlike a task-oriented dialogue, a chat is a dialogue that aims to gain fun and satisfaction from the dialogue itself. That is, it can be said that a chat dialogue system is a dialogue system that aims to entertain and satisfy people through dialogues.

The mainstream of research for conventional chat dialogue systems is the generation of natural responses to speeches (hereinafter also referred to as “user speeches”) made by users on various topics (hereinafter, also referred to as an “open domain”). So far, the goal has been to be able to somehow respond to any user species in open domain chats, and efforts have been made to generate appropriate response speeches in a question-and-answer format, and to realize dialogues of several minutes by properly combining such speeches.

### CITATION LIST

### Non Patent Literature

Non Patent Literature 1: Higashinaka, R., Imamura, K., Meguro, T., Miyazaki, C., Kobayashi, N., Sugiyama, H., Hirano, T., Makino, T., and Matsuo, Y., “Towards an open-domain conversational system fully based on natural language processing,” in Proceedings of the 25th International Conference on Computational Linguistics, pp. 928-939, 2014.

### SUMMARY OF THE INVENTION

### Technical Problem

However, open-domain response generation does not directly lead to the achievement of the original goal of the chat dialogue system, which is to entertain and satisfy people through dialogues. For example, in a conventional chat dialogue system, even if topics are locally connected, the user may not be able to understand where the dialogue is heading in a big picture. As a result, the user feels stressed because they cannot interpret the intention of speeches made by the dialogue system (hereinafter, also referred to as “system speeches”), or the dialogue system does not even understand its own speeches, and the user feels that system lacks dialogue capabilities, which is problematic.

In view of the above technical problem, an object of the present invention is to realize a dialogue system and a dialogue device capable of giving a user the impression that it has sufficient dialogue capabilities to correctly understand the user's speeches.

### Means for Solving the Problem

To solve the above problem, a dialogue method according to one aspect of the present invention is a dialogue method carried out by a dialogue system to which a personality is virtually set, including a speech presentation step of presenting a speech that is based at least on information contained in the most recently input user speech and on information set to the personality of the dialog system.

### Effects of the Invention

According to this invention, it is possible to give the impression that the system has sufficient dialogue capabilities to correctly understand the user's speeches.

### BRIEF DESCRIPTION OF DRAWINGS

FIG. 1 is a diagram illustrating a functional configuration of a dialogue system according to a first embodiment.

FIG. 2 is a diagram illustrating a functional configuration of a speech determination unit.

FIG. 3 is a diagram illustrating processing procedures of a dialogue method according to the first embodiment.

FIG. 4 is a diagram illustrating processing procedures for system speech determination and presentation according to the first embodiment.

FIG. 5 is a diagram illustrating a functional configuration of a dialogue system according to a second embodiment.

FIG. 6 is a diagram illustrating a functional configuration of a computer.

### DESCRIPTION OF EMBODIMENTS

The following describes embodiments of the present invention in detail. Note that, in the drawings, the components that have the same function are given the same number, and duplicate descriptions will be omitted. In the dialogue system according to the present invention, an “agent” to which a virtual personality is set, such as a robot or a chat partner that is virtually set on the display of a computer, has dialogues with a user. Therefore, an embodiment in which a humanoid robot is used as an agent will be described as a first embodiment, and an embodiment in which a chat partner virtually set on a computer display is used as an agent will be described as a second embodiment.

### First Embodiment

### [Configuration of Dialogue System and Operations of Components]

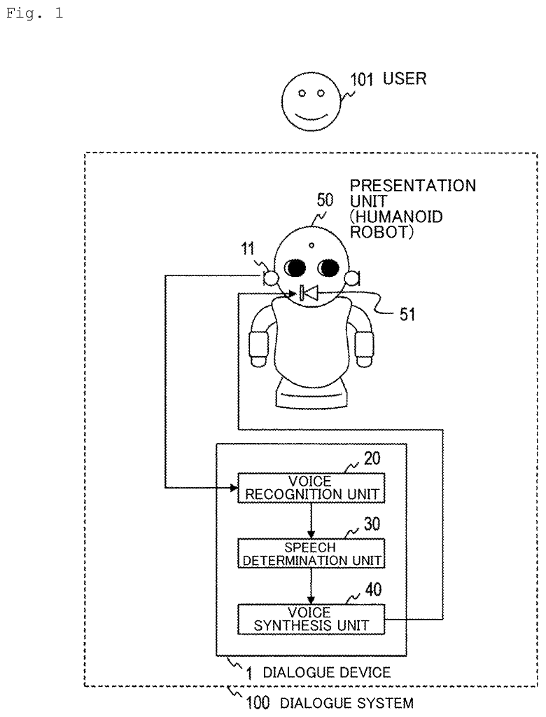

First, a configuration of a dialogue system according to the first embodiment and operations of the components thereof will be described. A dialogue system according to the first embodiment is a system in which one humanoid robot has dialogue with a user. As shown in FIG. 1, a dialogue system 100 includes, for example, a dialogue device 1, an input unit 10 constituted by a microphone 11, and a presentation unit 50 provided with at least a speaker 51. The dialogue device 1 includes, for example, a voice recognition unit 20, a speech determination unit 30, and a voice synthesis unit 40.

The dialogue device 1 is, for example, a special device formed by loading a special program into a well-known or dedicated computer that has a central processing unit (CPU), a main storage device (RAM: Random Access Memory), and so on. The dialogue device 1 performs various kinds of processing under the control of the CPU, for example. Data input to the dialogue device 1 or data obtained through various kinds of processing is, for example, stored in the main storage device, and the data stored in the main storage device is read out when needed and used for another kind of processing. At least a part of each processing unit of the dialogue device 1 maybe formed using a piece of hardware such as an integrated circuit.

### [Input Unit 10]

The input unit 10 may be integrated with, or partially integrated with, the presentation unit 50. In the example in FIG. 1, the microphone 11, which is a part of the input unit 10, is mounted on the head (at the position of an ear) of a humanoid robot 50, which is the presentation unit 50.

The input unit 10 is an interface for the dialogue system 100 to acquire the user's speech. In other words, the input unit 10 is an interface for inputting the user's speech to the dialogue system 100. For example, the input unit 10 is a microphone 11 that collects the user's spoken voice and converts it into a voice signal. The microphone 11 need only be capable of collecting the voice spoken by the user 101. That is to say, FIG. 1 is an example, and one microphone 11 or three or more microphones 11 may be provided. In addition, one or more microphones installed in a place different from where the humanoid robot 50 is located, such as the vicinity of the user 101, or a microphone array that includes a plurality of microphones may be employed as an input unit, and the humanoid robot 50 maybe configured without a microphone 11. The microphone 11 outputs the voice signal of the user's spoken voice obtained through the conversion. The voice signal output by the microphone 11 is input to the voice recognition unit 20.

### [Voice Recognition Unit 20]

The voice recognition unit 20 performs voice recognition on the voice signal of the spoken voice of the user input from the microphone 11, to convert the voice signal into a text that represents the content of the user's speech, and outputs the text to the speech determination unit 30. The voice recognition method carried out by the voice recognition unit 20 may employ any of the existing voice recognition technologies, and a method suitable for the usage environment or the like may be selected.

### [Speech Determination Unit 30]

The speech determination unit 30 determines the text representing the content of the speech from the dialogue system 100, and outputs the text to the voice synthesis unit 40. When a text representing the content of the user's speech is input from the voice recognition unit 20, the speech determination unit 30 determines the content of the speech from the dialogue system 100, based on the input text representing the content of the user's speech, and outputs the text to the voice synthesis unit 40.

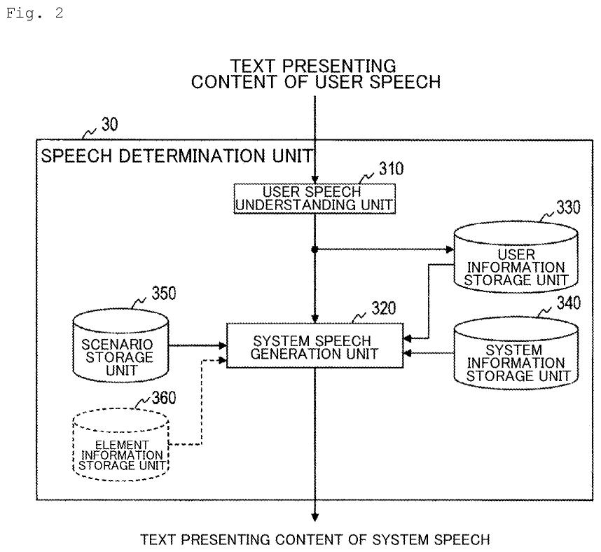

FIG. 2 shows a detailed functional configuration of the speech determination unit 30. The speech determination unit 30 receives a text representing the content of the user's speech input thereto, determines the text representing the content of the speech from the dialogue system 100, and outputs the text. The speech determination unit 30 includes, for example, a user speech understanding unit 310, a system speech generation unit 320, a user information storage unit 330, a system information storage unit 340, and a scenario storage unit 350. Note that the speech determination unit 30 may include an element information storage unit 360.

### [[User Information Storage Unit 330]]

The user information storage unit 330 is a storage unit that stores information regarding an attribute of the user acquired from the user's speech, based on various types of preset attributes. The attribute type is preset according to the scenario to be used in dialogue (i.e., a scenario stored in the scenario storage unit 350 described later). Examples of the types of attributes include a name, a residence prefecture, the experience of visiting a famous place in the residence prefecture, the experience of a specialty of a famous place in the residence prefecture, and whether the evaluation of the experience of the specialty is a positive evaluation or a negative evaluation. Information regarding each attribute is extracted from the text representing the content of the user's speech input to the speech determination unit 30 by the user speech understanding unit 310, which will be described later, and is stored in the user information storage unit 330.

### [[System Information Storage Unit 340]]

The system information storage unit 340 is a storage unit that stores attribute information regarding the personality (agent) set to the dialogue system. The attribute type is preset according to the scenario to be used in dialogue (i.e., a scenario stored in the scenario storage unit 350 described later). Examples of the types of attributes include a name, a residence prefecture, the experience of visiting a famous place in the prefecture, and the experience of a specialty of the famous place. Information regarding the attributes of the personality (agent) set to the dialogue system are preset and stored in the system information storage unit 340. However, the user speech understanding unit 310, which will be described later, may determine information regarding the attribute of the personality (agent) set to the dialogue system according to the extracted user attribute information, and store it in the system information storage unit 340.

### [[Element Information Storage Unit 360]]

The element information storage unit 360 is a storage unit that stores information regarding various types of elements other than attribute information regarding the user and the agent, which is to be inserted into a speech template of the system speech of the scenario to be used in dialogue (i.e., a scenario stored in the scenario storage unit 350 described later). Examples of the types include a famous place in a prefecture, and a specialty of the famous place in the prefecture. Examples of element information include “Nagatoro”, which is a famous place in Saitama prefecture, and “cherry blossoms”, which is a specialty of Nagatoro. Element information may be preset and stored in the element information storage unit 360. However, the user speech understanding unit 310, which will be described later, may acquire element information from a resource published on the Web (for example, Wikipedia (registered trademark)) according to the extracted user attribute information and personality attribute information set to the dialogue system (for example, the user's residence prefecture or the system's residence prefecture), and store it in the element information storage unit 360. Note that, if element information is beforehand included in the speech template of the scenario to be stored in the scenario storage unit 350, the speech determination unit 30 need not be provided with the element information storage unit 360.

### [[Scenario Storage Unit 350]]

The scenario storage unit 350 stores dialogue scenarios in advance. Each dialogue scenario stored in the scenario storage unit 350 includes transition of the state of the intention of a speech in the flow from the beginning to the end of the dialogue within a finite range, candidates for the intention of the speech of the previous user speech in each speech state of the dialogue system 100, candidates for system speech templates corresponding to the candidates for the intention of the previous user speech (i.e. templates for the content of a speech of for the dialogue system 100 to express the speech intention that does not contradict the speech intention of the previous user speech), and candidates for the speech intention of the next user speech corresponding to the candidates for the speech templates (i.e. candidates for the speech intention of the next user speech made for the speech intention of the dialogue system 100 in the candidates of the speech templates). Note that the speech templates may include only the text representing the content of the speech of the dialogue system 100. Alternatively, instead of a part of the text representing the content of the speech of the dialogue system 100, the speech templates may include information that specifies that certain types of attribute information regarding the user is to be included, information that specifies that certain types of attribute information regarding the personality set to the dialogue system is to be included, and information that specifies that information regarding a given element is to be included, for example.

### [[User Speech Understanding Unit 310]]

The user speech understanding unit 310 acquires the result of understanding of the intention of the user's speech and attribute information regarding the user from the text representing the content of the user speech input to the speech determination unit 30, and outputs them to the system speech generation unit 320. The user speech understanding unit 310 stores the acquired attribute information regarding the user to the user information storage unit 330 as well.

### [[System Speech Generation Unit 320]]

The system speech generation unit 320 determines a text representing the content of the system speech and outputs it to the voice synthesis unit 40. The system speech generation unit 320 acquires a speech template corresponding to the user's speech intention (i.e., the most recently input user speech intention) input from the user speech understanding unit 310 from among the speech templates corresponding to the candidates for the speech intention of the previous user speech in the current state in the scenario stored in the scenario storage unit 350. If there are a plurality of speech templates that are consistent with the user's speech intention input from the user speech understanding unit 310, the system speech generation unit 320 identifies and acquires a speech template that is consistent with the attribute information regarding the personality (agent) set to the dialogue system stored in the system information storage unit 340. As a matter of course, the system speech generation unit 320 identifies and acquires the speech template that does not contradict attribute information regarding the user input from the user speech understanding unit 310, and that does not contradict attribute information regarding the user already stored in the user information storage unit 330. Next, if the acquired speech template contains information specifying that attribute information of a predetermined type regarding the user is to be included, and the attribute information of the type regarding the user has not been acquired from the user speech understanding unit 310, the system speech generation unit 320 acquires attribute information of the type regarding the user from the user information storage unit 330. If the acquired speech template contains information specifying that attribute information of a predetermined type regarding the personality (agent) set to the dialogue system is to be included, the system speech generation unit 320 acquires attribute information of the predetermined type regarding the personality (agent) set to the dialogue system from the system information storage unit 330. If the acquired speech template contains information specifying that element information of a predetermined type is to be included, the system speech generation unit 320 acquires the element information from the element information storage unit 360. Thereafter, the system speech generation unit 320 inserts the above acquired information into the speech template at a specified position, and determines it as a text representing the content of the system speech.

### [Voice Synthesis Unit 40]

The voice synthesis unit 40 converts the text representing the content of the system speech input from the speech determination unit 30 into a voice signal representing the content of the system speech, and outputs the voice signal to the presentation unit 50. The voice synthesis method carried out by the voice synthesis unit 40 may employ any of the existing voice synthesis technologies, and a method suitable for the usage environment or the like may be selected.

### [Presentation Unit 50]

The presentation unit 50 is an interface for presenting the content of the speech determined by the speech determination unit 30 to the user. For example, the presentation unit 50 is a humanoid robot manufactured by imitating a human shape. This humanoid robot outputs a voice, i.e., presents a speech, corresponding to a voice signal representing the content of the speech input from the voice synthesis unit 40, for example, from the speaker 51 mounted on the head. The speaker 51 may be capable of outputting a voice corresponding to the voice signal representing the content of the speech input from the voice synthesis unit 40. That is to say, FIG. 1 is an example, and one speaker 51 or three or more speakers 51 may be provided. In addition, one or more speakers installed in a place different from where the humanoid robot 50 is located, such as the vicinity of the user 101, or a speaker array that includes a plurality of speakers may be provided, and the humanoid robot 50 may be configured without a speaker 51.

### [Features of Dialogue Method Carried Out by Dialogue System According to Present Invention]

Next, the features of the dialogue method carried out by the dialogue system according to the present invention will be described based on specific examples of a dialogue between the dialogue system and the user. In the following specific example, “S” denotes a system speech, and “U” denotes a user speech. t (i) (i=0, 1, 2, . . . ) denotes a speech uttered during a dialogue, and i is a number indicating the order of the speech.

### [Specific Examples of Dialogues]

t(1) S: Hello! May I ask for your name?

t(2) U: My name is Sugiyama.

t(3) S: You are Sugiyama. I'm Riko. Nice to meet you. What prefecture do you live in, Sugiyama?

t(4) U: I live in Saitama prefecture.

t(5) S: I see, Saitama prefecture. I like Saitama. I'd like to go there. Nagatoro is famous, isn't it?

t(6) U: Nagatoro is close, so I sometimes go there by bicycle.

t(7) S: I'm jealous you have nice cherry blossoms. I love having a cherry-blossom viewing party. How are cherry blossoms in Nagatoro?

t(8) U: The row of cherry blossom trees along the Arakawa River is spectacular, and in the spring, it looks like a tunnel of cherry blossoms.

t(9) S: I love cherry blossoms. By the way, I live in Aomori prefecture, and when it comes to cherry blossoms, I recommend Hirosaki Castle. Have you been there, Sugiyama?

### Features of Present Invention

A feature of the dialogue method carried out by the dialogue system according to the present invention is that a system speech is presented based not only on information contained in the previous user speech (the most recently input user speech), but also on the information set to the personality of the dialogue system. Hereinafter, the features of the present invention will be described with reference to the speeches included in the specific examples.

### [[Example 1-1]] “I Like Saitama” in System Speech t(5)

The part saying “I like Saitama” in the system speech t(5) is a speech that is based not only on information indicating “User's residence prefecture=Saitama prefecture” input through the previous user speech t(4), but also on information indicating “agent's residence prefecture=Aomori prefecture” set in advance to the personality (agent) set to the dialogue system. That is to say, the part saying “I like Saitama” in the system speech t(5) is determined based on the fact that the residence prefecture is different between the user and the agent. If information indicating “agent's residence prefecture=Saitama prefecture” is set and the residence prefecture is the same for the user and the agent, the utterance will be, for example, “Saitama is good, isn't it?”.

### [[Example 1-2]] “I'd Like to go There” in System Speech t(5)

The part saying “I'd like to go there” in the system speech t(5) is a speech that is based not only on information indicating “User's residence prefecture=Saitama prefecture” input through the previous user speech t(4), but also on information indicating “agent's residence prefecture=Aomori prefecture” and “the experience of visiting Saitama prefecture=NO” set in advance to the agent.

### [[Example 1-3]] “how are Cherry Blossoms in Nagatoro?” in System Speech t(7)

The part saying “How are cherry blossoms in Nagatoro?” in the system speech t(7) is a speech that is based not only on information indicating “user's experience to visiting Nagatoro=YES” input through the previous user speech t(6), but also on information indicating “agent's experience of visiting Saitama prefecture=NO” set in advance to the agent.

Note that in the case of a speech that is based at least on information contained in the previous user speech and on information set to the personality (agent) of the speech system as in Examples 2-1 and 2-2 shown below, a speech that is also based on a user speech in the past may be presented.

### [[Example 2-1]] “I'm Jealous You have Nice Cherry Blossoms” in System Speech t(7)

The part saying “I'm jealous you have nice cherry blossoms” in the system speech t(7) is a speech that is based on information indicating “user's experience to visiting Nagatoro=YES” input through the previous user speech t(6), “user's residence prefecture=Saitama prefecture” set through the user speech t(4) in the past, and information indicating “agent's residence prefecture=Aomori prefecture” set to the agent in advance. Even if “user's experience to visiting Nagatoro=YES” in the previous user speech t(6), if “user's residence prefecture=Saitama” is not true or if “agent's residence prefecture=Saitama” is true, a speech saying “I'm jealous” is not suitable, and therefore a speech that is different from “I'm jealous you have nice cherry blossoms” is to be made as the system speech t(7). Also, if “user's experience of visiting Nagatoro=YES” is not true when, for example, the previous user speech t(6) says “Is it?”, or if the user makes a speech indicating that the user does not know Nagatoro or that the user does not agree with the fact that Nagatoro is famous, the system speech t(7) saying “I'm jealous you have nice cherry blossoms” is an unnatural speech and is not appropriate. Therefore, in such a case, the agent makes, as the system speech t(7), a speech that is simply in line with the user's speech, such as “Oh, isn't it so famous?”, or a speech that continues the agent's own claim while accepting that the user does not agree with the agent, such as “Well, I've heard that it's a really good place before”, for example.

### [[Example 2-2]] “by the Way, I Live in Aomori Prefecture, and when it Comes to Cherry Blossoms, I Recommend Hirosaki Castle.” in System Speech t(9)

The part saying “By the way, I live in Aomori prefecture, and when it comes to cherry blossoms, I recommend Hirosaki Castle.” in the system speech t(9) is a speech that is based on the user's positive evaluation input in the previous user speech t(8), information indicating “user's residence prefecture=Saitama prefecture” input in the user speech t(4) in the past, and information indicating “agent's residence prefecture=Aomori prefecture” set to the agent in advance. If information indicating “user's residence prefecture=Aomori prefecture” was input in the past and the user's residence prefecture and the agent's residence prefecture are the same, the beginning of the above part in the system speech t(9) is to be a speech saying “Actually, I” instead of the speech saying “By the way, I”, for example. Also, if the user's evaluation is a negative evaluation, the system speech t(9) is to be a speech directed to a subject other than cherry blossoms.

Note that, as in Example 3-1 below, when a system speech is to be made based at least on information contained in the previous user speech and on information set to the personality (agent) of the dialogue system, if there are many possible options in the previous user speech, a system speech may be presented based on a difference or sameness regarding the information contained in the previous user speech and the information set to the personality (agent) of the dialogue system.

### [[Example 3-1]] “What Prefecture do You Live in, Sugiyama?” in System Speech t(3) and “I Like Saitama. I'd Like to go There” in System Speech t(5)

The part of the speech for asking a question “What prefecture do you live in, Sugiyama?” in the system speech t(3) is a question for which there are 47 possible options corresponding to the prefectures in Japan. In contrast, in the user speech t(4), although the user's residence prefecture is answered, the part of the system speech t(5) saying “I like Saitama. I'd like to go there” is not a speech corresponding directly to the user's residence prefecture, and is a speech that is based on a difference or sameness regarding living experience and visiting experience of the user and the agent. However, the user feels that the agent understands the user's speech.

### [Processing Procedures of Dialogue Method Carried Out by Dialogue System 100]

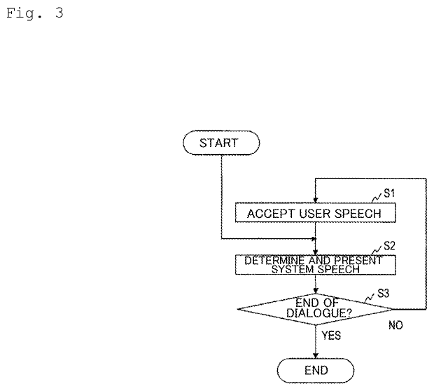

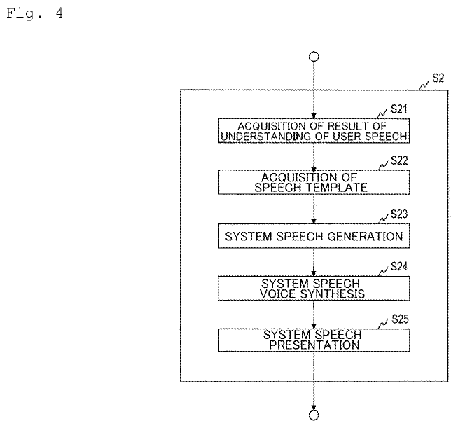

Next, the processing procedures of the dialogue method carried out by the dialogue system 100 according to the first embodiment are as shown in FIG. 3, and examples of detailed processing procedures in the section for determining and presenting a system speech (step S2 in FIG. 3) are as shown in FIG. 4.

### [Determination and Presentation of System Speech at First Time (Step S2 at First Time)]

Upon the dialogue system 100 starting a dialogue operation, first, the system speech generation unit 320 of the speech determination unit 30 reads out a speech template fora system speech to be made in the initial state of the scenario, from the scenario storage unit 350, and outputs a text representing the content of the system speech, and the voice synthesis unit 40 converts the text into a voice signal, and the presentation unit 50 presents the voice signal. The system speech made in the initial state of the scenario is a speech that includes a greeting and asks the user a question as in the system speech t(1), for example.

### [Acceptance of User Speech (Step S1)]

The input unit 10 collects the user's spoken voice and converts it into a voice signal, and the voice recognition unit 20 converts the voice signal into a text and outputs the text representing the content of the user's speech to the speech determination unit 30. Examples of texts representing the content of the user's speech include the user speech t(2) responding to the system speech t(1), the user speech t(4) responding to the system speech t(3), the user speech t(6) responding to the system speech t(5), and the user speech t(8) responding to the system speech t(7).

[Determination and Presentation of System Speech (Step S2 for Other than First Time)]

The speech determination unit 30 determines a text representing the content of a system speech that is based at least on information contained in the previous user speech and on information set to the personality of the dialogue system, the voice synthesis unit 40 converts the text into a voice signal, and the presentation unit 50 presents the voice signal. System speeches to be presented are the system speech t(3) responding to the user speech t(2), the system speech t(5) responding to the user speech t(4), the system speech t(7) responding to the user speech t(6), and the system speech t(9) responding to the user speech t(8). The details of step S2 will be described later in [Processing Procedures for System Speech Determination and Presentation].

### [Continuation and Termination of Dialogue (Step S3)]

If the current state in the scenario stored in the scenario storage unit 350 is the final state, the system speech generation unit 320 of the speech determination unit 30 operates so that the dialogue system 100 terminates the dialogue operation, and otherwise continues the dialogue by performing step S1.

### [Processing Procedures for System Speech Determination and Presentation]

The details of the processing procedures for system speech determination and presentation (step S2) are as shown in step S21 to step S25 described below.

### [Acquisition of Result of User Speech Understanding (Step S21)]

The user speech understanding unit 310 acquires the result of understanding of the intention of the user's speech and attribute information regarding the user from the text representing the content of the user speech input to the speech determination unit 30, and outputs them to the system speech generation unit 320. The user speech understanding unit 310 stores the acquired attribute information regarding the user to the user information storage unit 330 as well.

For example, if the text representing the content of the input user speech is the speech t(2), the user speech understanding unit 310 acquires a result indicating “speech intention=a name is spoken” as the result of understanding of the intention of the user speech, and acquires “Sugiyama”, which is the “user's name”, as attribute information regarding the user. For example, if the text representing the content of the input user speech is the speech t(4), the user speech understanding unit 310 acquires a result indicating “speech intention=a residence prefecture is spoken” as the result of understanding of the intention of the user speech, and acquires “Saitama prefecture”, which is the “user's residence prefecture”, as attribute information regarding the user. If the text representing the content of the input user speech is the speech t(6), the user speech understanding unit 310 acquires a result indicating “speech intention=the presence of the experience of visiting a famous place is spoken” as the result of understanding of the intention of the user speech, and acquires “the experience of visiting a famous place in the user's residence prefecture=YES” as attribute information regarding the user. If the text representing the content of the input user speech is the speech t(8), the user speech understanding unit 310 acquires a result indicating “speech intention=the experience of a specialty is spoken” and “speech intention=positive evaluation of the experience of a specialty is spoken” as the results of understanding of the intention of the user speech, and acquires “the experience of a specialty of a famous place in the user's residence prefecture=YES” as attribute information regarding the user.

Note that step S21 is not performed in the initial step S2.

### [Acquisition of Speech Template (Step S22)]

The system speech generation unit 320 acquires a speech template corresponding to the user's speech intention input from the user speech understanding unit 310 from among the speech templates corresponding to the candidates for the speech intention of the previous user speech in the current state in the scenario stored in the scenario storage unit 350. That is to say, the system speech generation unit 320 acquires a speech template for a speech intention that does not contradict the user's speech intention of the most recently input user speech. If there are a plurality of speech template for a speech intention that does not contradict the user's speech intention input from the user speech understanding unit 310, the system speech generation unit 320 specifies and acquires one speech template that has the feature described below. The feature is that the speech template does not contradict attribute information regarding the personality (agent) set to the dialogue system stored in the system information storage unit 340, and does not contradict attribute information regarding the user stored in the user information storage unit 330.

Note that the case in which only one speech template corresponding to the intention of the input user speech is included in the speech templates corresponding to the candidates for the intention of the previous user speech in the current state is a case in which a speech template that does not contradict attribute information regarding the agent or attribute information regarding the user has been created at the stage of creating the sates of the scenario to be stored in the scenario storage unit 350. Therefore, there is no risk of a speech template that contradicts attribute information regarding the agent and attribute information regarding the user being selected.

For example, if the text representing the content of the input user speech is the speech t(2), the system speech generation unit 320 acquires a speech template saying “You are [user name]. I'm [agent name]. Nice to meet you. What prefecture do you live in, [user name]?”. Note that the portions in [ ] (square brackets) in the speech template are information specifying that information is to be acquired from the user speech understanding unit 310, the user information storage unit 330, the system information storage unit 340, or the element information storage unit 360 and is to be included therein. If the text representing the content of the input user speech is the speech t(2), the result of understanding of the intention of the user speech is “speech intention=a name is spoken”, and therefore the system speech generation unit 320 acquires the above speech template corresponding to “speech intention=a name is spoken”. However, if the result of understanding of the intention of the user speech is something different, such as “speech intention=a name is not spoken”, the system speech generation unit 320 may acquire a speech template corresponding to the result of understanding of the intention of the user speech. That is to say, it is preferable that the scenarios in the dialogue scenario storage unit 350 store, in advance, cases in which a user speech contains or does not contain a predetermined type of information, and candidates for the speech templates corresponding to these cases, in association with each other, and the result of understanding regarding whether or not the input user speech contains the predetermined type of information is acquired, and a speech template corresponding to the result of understanding is selected from among the candidates for the speech template.

Also, for example, if the text representing the content of the input user speech is the speech t(4), the system speech generation unit 320 acquires a speech template saying “I see, [user's residence prefecture]. I like [user's residence prefecture]. I'd like to go there. [famous place in [user's residence prefecture]] is famous, isn't it?”. Also, for example, if the text representing the content of the input user speech is the speech t(6), the system speech generation unit 320 acquires a speech template saying “I'm jealous you have nice [specialty in famous place in [user's residence prefecture]]. I love [action corresponding to specialty in famous place in [user's residence prefecture]]. How is [specialty in famous place in [user's residence prefecture]] in [famous place in [user's residence prefecture]]?”.

Also, for example, if the text representing the content of the input user speech is the speech t(8), the system speech generation unit 320 acquires a speech template saying “I love [specialty in famous place in [user's residence prefecture]]. By the way, I live in [agent's residence prefecture], and when it comes to [specialty in famous place in [user's residence prefecture]], I recommend [famous place in [agent's residence prefecture] whose specialty is [specialty in famous place in [user's residence prefecture]] ]. Have you been there, [user name] ?”. Note that there two candidates for the intention of the user speech corresponding to the system speech t(7), namely “speech intention=the experience of a specialty is spoken” and “speech intention=the experience of a specialty is not spoken”, and “speech intention=the experience of a specialty is spoken” can further classified into two cases, namely “speech intention=positive evaluation of the experience of a specialty is spoken” and “speech intention=negative evaluation of the experience of a specialty is spoken”. Therefore, regarding the “speech intention=the experience of a specialty is spoken”, it is necessary that candidates for speech templates respectively corresponding to the two speech intentions, namely “speech intention=positive evaluation of the experience of a specialty is spoken” and “speech intention=negative evaluation of the experience of a specialty is spoken” are stored in advance for the scenario in the dialogue scenario storage unit 350 so as to be selectable. That is to say, it is preferable that the scenarios in the dialogue scenario storage unit 350 store, in advance, a case in which a user speech contains positive evaluation of a predetermined type and a case in which a user speech contains negative evaluation of a predetermined type, and candidates for the speech templates corresponding to these cases, in association with each other, and the result of understanding regarding whether the input user speech contains the positive evaluation of the predetermined type or the negative evaluation of the predetermined type is acquired, and a speech template corresponding to the result of understanding is selected from among the candidates for the speech template.

Note that, in step S22 in step S2 at the first time, the system speech generation unit 320 acquires speech template in the initial state of the scenario stored in the scenario storage unit 350.

### [System Speech Generation (Step S23)]

If the speech template acquired in step S22 contains information specifying that attribute information of a predetermined type regarding the user, not acquired from the user speech understanding unit 310, is to be included, the system speech generation unit 320 acquires the attribute information of the predetermined type regarding the user from the user information storage unit 330. If the acquired speech template contains information specifying that attribute information of a predetermined type regarding the personality (agent) set to the dialogue system is to be included, the system speech generation unit 320 acquires attribute information of the predetermined type regarding the personality (agent) set to the dialogue system from the system information storage unit 330. If the acquired speech template contains information specifying that element information of a predetermined type is to be included, the system speech generation unit 320 acquires the element information from the element information storage unit 360. Thereafter, the system speech generation unit 320 inserts the above acquired information into the speech template at a specified position, and determines it as a text representing the content of the system speech.

For example, if the text representing the content of the input user speech is the speech t(2), the system speech generation unit 320 acquires “Riko”, which is [agent name], from the system information storage unit 340, inserts it into the above-described speech template together with “Sugiyama”, which is “user name” acquired from the user speech understanding unit 310, determines it as the text of the speech t(3), and outputs it. If the text representing the content of the input user speech is the speech t(4), the system speech generation unit 320 acquires “Saitama prefecture”, which is [user's residence prefecture], from the user information storage unit 330, acquires “Nagatoro”, which is [famous place in[user's residence prefecture]], i.e., a famous place in Saitama prefecture, from the element information storage unit 360, inserts them into the above-described speech template, determines it as the text of the speech t(5), and outputs it. If the text representing the content of the input user speech is the speech t(6), the system speech generation unit 320 acquires “Nagatoro”, which is [famous place in[user's residence prefecture]], i.e., a famous place in Saitama prefecture, “cherry blossoms”, which is [a specialty of famous place in [user's residence prefecture] ], i.e., a specialty of Nagatoro, which is a famous place in Saitama prefecture, and “cherry-blossom viewing party”, which is [action corresponding to specialty in famous place in [user's residence prefecture]], i.e., an action corresponding to cherry blossoms, from the element information storage unit 360, inserts them into the above-described speech template, determines it as the text of the speech t(7), and outputs it. If the text representing the content of the input user speech is the speech t(8), the system speech generation unit 320 acquires “Sugiyama”, which is [user name], from the user information storage unit 330 acquires “Aomori prefecture”, which is [agent's residence prefecture], from the system information storage unit 340, acquires [specialty of famous place in [user's residence prefecture]], which is “cherry blossoms”, and [[famous place in [agent's residence prefecture]] whose specialty is [specialty of famous place in [user's residence prefecture]]], i.e., “Hirosaki Castle” whose specialty is cherry blossoms, from the element information storage unit 360, inserts them into the above-described speech template, determines it as the text of the speech t(9), and outputs it. Note that as “prefecture” if omitted from “Saitama prefecture” in a portion of the speech t(5), the expression indicated by the acquired information may be changed before being inserted into the speech template as long as the meaning of the acquired information does not change.

### [System Speech Voice Synthesis (Step S24)]

The voice synthesis unit 40 converts the text representing the content of the system speech input from the speech determination unit 30 into a voice signal representing the content of the system speech, and outputs the voice signal to the presentation unit 50.

### [System Speech Presentation (Step S25)]

The presentation unit 50 presents a voice corresponding to a voice signal representing the content of a speech input from the voice synthesis unit 40.

The processing procedures of the dialogue method carried out by the dialogue system 100 has been described in detail above. In short, a dialogue method carried out by the dialogue system 100 is a dialogue method carried out by a dialogue system to which a personality is virtually set, and is a dialogue method for presenting a speech that is based at least on information contained in the most recently input user speech and on information set to the personality of the dialog system. The dialogue method carried out by the dialogue system 100 may be a dialogue method for presenting a speech that does not contradict information contained in the most recently input user speech or information contained in a user speech input in the past, based on information contained in the user speech input in the past as well. More specifically, the dialogue method carried out by the dialogue system 100 may be a dialogue method for generating a speech that does not contradict a result of understanding of an intention of a most recently input user speech, information contained in the most recently input user speech, information contained in a user speech input in the past, or information set to the personality of the dialog system, and presenting the generated speech.

Also, it is preferable that speech generation processing carried out by the dialogue system 100 is processing carried out to generate a speech according to a dialogue scenario stored in the dialogue scenario storage unit 350 in advance in association with speech templates, in a case in which the user speech contains or does not contain information of a predetermined type, and a case in which the user speech contains positive or negative information of a predetermined type, respectively. The generation step may be processing in which a result of understanding indicating at least whether or not the most recently input user speech contains the information of the predetermined type, or whether the most recently input user speech contains positive information or negative information of the predetermined type is acquired, and a speech that is based on a speech template corresponding to the result of understanding, of the speech templates, is generated.

Also, the dialogue method carried out by the dialogue system 100 may include: presenting a speech for asking a question about an element (hereinafter referred to as a “target element”) that has a finite number of possible options; accepting a user speech responding to the presented speech; and presenting a speech based on a difference or sameness between one of the options corresponding to the target element contained in the user speech accepted in the answer accepting step, and one of the options corresponding to the target element set to the personality of the dialogue system.

### Second Embodiment

Although an example in which voice dialogue is performed using a humanoid robot as an agent is described in the first embodiment, the presentation unit of the dialogue system according to the present invention may be a humanoid robot having a body or the like, or a robot without a body or the like. Also, the dialogue system according to the present invention is not limited to the above examples, and may be in a form in which dialogue is performed using an agent that does not have an entity such as a body, and does not have a vocalization mechanism, unlike a humanoid robot. Examples of such forms include a form in which a dialogue is performed using an agent that is displayed on a computer screen. More specifically, the present invention is also applicable to a form in which a user's account and a dialogue device's account have a dialogue in a chat such as “LINE” (registered trademark) in which a dialogue is performed through text messages. Such a form will be described as a second embodiment. In the second embodiment, a computer that has a screen for displaying the agent needs to be located in the vicinity of a human, but the computer and the dialogue device may be connected to each other via a network such as the Internet. That is to say, the dialogue system according to the present invention is applicable not only to dialogues in which speakers such as a human and a robot actually talk face to face, but also to conversations in which speakers communicate with each other via a network.

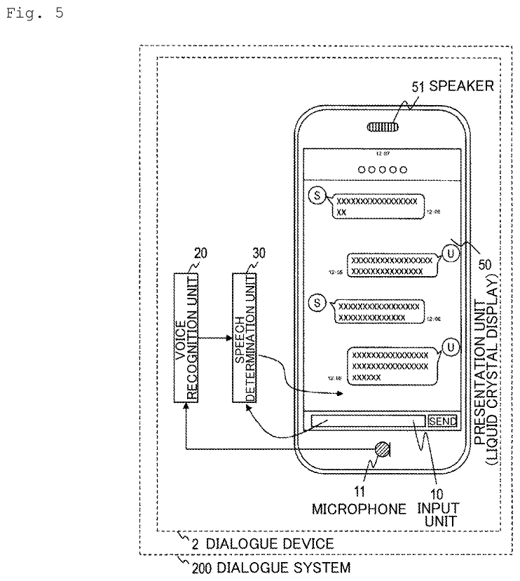

As shown in FIG. 5, a dialogue system 200 according to the second embodiment includes, for example, one dialogue device 2. The dialogue device 2 according to the second embodiment includes, for example, an input unit 10, a voice recognition unit 20, a speech determination unit 30, and a presentation unit 50. The dialogue device 2 may include, for example, a microphone 11 and a speaker 51.

The dialogue device 2 according to the second embodiment is, for example, an information processing device which is, for example, a mobile terminal such as a smartphone or a tablet, or a desktop or laptop personal computer. The following describes a case in which the dialogue device 2 is a smartphone. The presentation unit 50 is a liquid crystal display provided on the smartphone. A chat application window is displayed on this liquid crystal display, and the content of chat dialogue is displayed in the window in chronological order. It is assumed that a virtual account corresponding to the virtual personality controlled by the dialogue device 2 and the user's account participate in this chat. That is to say, the present embodiment is an example in which the agent is a virtual account displayed on the liquid crystal display of the smartphone which is the dialogue device. The user can input the content of a speech to the input unit 10, which is an input area provided in the chat window, using a software keyboard, and post the speech to the chat through their own account. The speech determination unit 30 determines the content of a speech from the dialogue device 2 based on the post from the user's account, and posts the speech to the chat through the virtual account. Note that it is possible to employ a configuration that utilizes the microphone 11 mounted on the smartphone and a voice recognition function to enable the user to input the content of a speech to the input unit 10 by voice. In addition, it is possible to employ a configuration that utilizes the speaker 51 mounted on the smartphone and a voice synthesis function to output the content of a speech acquired from each dialogue system from the speaker 51 with a voice corresponding to each virtual account.

Although embodiments of the present invention have been described above, the specific configuration is not limited to these embodiments, and, as a matter of course, even if the design is changed when necessary, without departing from the spirit of the present invention, such a configuration is also included in the present invention.

### [Program and Recording Medium]

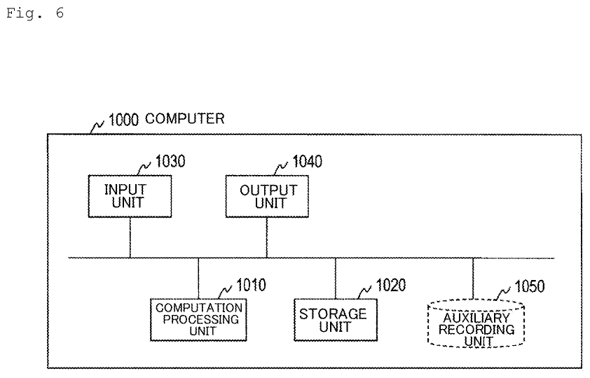

When various processing functions in each dialogue device described in the above embodiments are to be realized using a computer, the contents of processing of the functions that the dialogue device needs to have are to be written as a program. By loading this program to a storage unit 1020 of a computer shown in FIG. 6 to operate a computation processing unit 1010, an input unit 1030, an output unit 1040, and so on, it is possible to realize various processing functions in each of the above-described dialogue devices on the computer.

The program describing the content of processing can be recorded on a computer-readable recording medium. The computer-readable recording medium is, for example, a non-temporary recording medium, and specific examples thereof include a magnetic recording device, an optical disk, and so on.

In addition, the distribution of this program is carried out by, for example, selling, transferring, or renting a portable recording medium such as a DVD or a CD-ROM on which the program is recorded. Furthermore, the program may be stored in a storage device of a server computer, and the program may be distributed by transferring the program from the server computer to another computer via a network.

A computer that executes such a program first transfers a program recorded on the portable recording medium or a program transferred from the server computer to an auxiliary recording unit 1050, which is a non-transitory storage device thereof, for example. When processing is to be executed, the computer reads the program stored in the auxiliary recording unit 1050, which is a non-transitory storage device, into the storage unit 1020, and executes processing according to the read program. In addition, in another execution form of this program, the computer may read the program directly from a portable recording medium into the storage unit 1020 and execute processing according to the program. Also, the computer may sequentially execute processing according to a received program each time a program is transferred from a server computer to this computer. In addition, it is possible to employ a configuration with which the above processing is executed by a so-called ASP (Application Service Provider) type service that realizes processing functions by using an instruction to executing the program and acquiring the result, without transferring the program from the server computer to this computer. Note that the program in such a form includes information that is to be used by a computer to perform processing, and is equivalent a program (for example, data that is not a direct command to a computer, but has properties of defining processing to be performed by the computer).

In addition, although the present device in such a form is formed by executing a predetermined program on a computer, at least a part of the content of such processing maybe realized using hardware.

1. A computer-implemented method for virtually setting a personality of an agent in a dialogue, comprising:
presenting a speech that is based at least on information contained in a most recently input user speech and on information set to the personality associated with the agent.

2. The computer-implemented method according to claim 1, further comprising:
presenting a speech that does not contradict information contained in a most recently input user speech, information contained in a user speech input in the past, or information set to the personality of the agent.

3. The computer-implemented method according to claim 2, further comprising
generating a speech that does not contradict a result of understanding of an intention of a most recently input user speech, information contained in the most recently input user speech, information contained in a user speech input in the past, or information set to the personality of the agent; and
presenting the speech.

4. The computer-implemented method according to claim 1, further comprising
generating a speech according to a dialogue scenario stored in advance in association with speech templates, based on whether the user speech contains or does not contain information of a predetermined type, and based on whether the user speech contains positive or negative information of a predetermined type, respectively, wherein a result of understanding indicating at least whether or not the most recently input user speech contains the information of the predetermined type, or whether the most recently input user speech contains positive information or negative information of the predetermined type is acquired, and a speech that is based on a speech template corresponding to the result of understanding, of the speech templates, is generated,
wherein the speech is presented.

5. The computer-implemented method according to claim 1, further comprising:
presenting a speech for asking a question about a target element that has a finite number of options; and
accepting a user speech responding to the speech,
wherein a speech is presented based on a difference or sameness between one of options corresponding to the target element contained in the user speech, and one of options corresponding to the target element set to the personality of the agent.

6. The computer-implemented method according to claim 3,
wherein at least one speech template of speech templates stored in advance for states of a dialogue scenario is written using element types,
information regarding the element types is stored in advance separately from the templates, and
a speech is generated by inserting information regarding the elements stored in advance separately from the speech templates, into a type of the element in the speech template corresponding to a current state selected from the dialogue scenario.

7. A system for setting a personality of an agent in a dialogue, the system comprising a circuit configured to execute a method comprising:
accepting a user speech; and
presenting a speech that is based at least on information contained in a most recently input user speech and on information set to the personality of the agent.

8. A dialogue device for determining a speech to set a personality of an agent in a dialogue, the dialogue device comprising a circuit configured to execute a method comprising:
determining a speech that is based at least on information contained in a most recently input user speech and on information set to the personality of the dialog system.

9-10. (canceled)

11. The computer-implemented method according to claim 2, further comprising:
presenting a speech for asking a question about a target element that has a finite number of options; and
accepting a user speech responding to the speech,
wherein a speech is presented based on a difference or sameness between one of options corresponding to the target element contained in the user speech, and one of options corresponding to the target element set to the personality of the agent.

12. The system according to claim 7, the circuit further configured to execute a method comprising:
presenting a speech that does not contradict information contained in a most recently input user speech, information contained in a user speech input in the past, or information set to the personality of the agent.

13. The system according to claim 12, the circuit further configured to execute a method comprising:
generating a speech that does not contradict a result of understanding of an intention of a most recently input user speech, information contained in the most recently input user speech, information contained in a user speech input in the past, or information set to the personality of the agent; and
presenting the speech.

14. The system according to claim 7, the circuit further configured to execute a method comprising:
generating a speech according to a dialogue scenario stored in advance in association with speech templates, based on whether the user speech contains or does not contain information of a predetermined type, and based on whether the user speech contains positive or negative information of a predetermined type, respectively, wherein a result of understanding indicating at least whether or not the most recently input user speech contains the information of the predetermined type, or whether the most recently input user speech contains positive information or negative information of the predetermined type is acquired, and a speech that is based on a speech template corresponding to the result of understanding, of the speech templates, is generated,
wherein the speech is presented.

15. The system according to claim 7, the circuit further configured to execute a method comprising:
presenting a speech for asking a question about a target element that has a finite number of options; and
accepting a user speech responding to the speech,
wherein a speech is presented based on a difference or sameness between one of options corresponding to the target element contained in the user speech, and one of options corresponding to the target element set to the personality of the agent.

16. The system according to claim 13, the circuit further configured to execute a method comprising:
wherein at least one speech template of speech templates stored in advance for states of a dialogue scenario is written using element types,
information regarding the element types is stored in advance separately from the templates, and
a speech is generated by inserting information regarding the elements stored in advance separately from the speech templates, into a type of the element in the speech template corresponding to a current state selected from the dialogue scenario.

17. The system according to claim 12, the circuit further configured to execute a method comprising:
presenting a speech for asking a question about a target element that has a finite number of options; and
accepting a user speech responding to the speech,
wherein a speech is presented based on a difference or sameness between one of options corresponding to the target element contained in the user speech, and one of options corresponding to the target element set to the personality of the agent.

18. The dialogue device according to claim 8, the circuit further configured to execute a method comprising:
presenting a speech that does not contradict information contained in a most recently input user speech, information contained in a user speech input in the past, or information set to the personality of the agent.

19. The dialogue device according to claim 18, the circuit further configured to execute a method comprising:
generating a speech that does not contradict a result of understanding of an intention of a most recently input user speech, information contained in the most recently input user speech, information contained in a user speech input in the past, or information set to the personality of the agent; and
presenting the speech.

20. The dialogue device according to claim 8, the circuit further configured to execute a method comprising:
generating a speech according to a dialogue scenario stored in advance in association with speech templates, based on whether the user speech contains or does not contain information of a predetermined type, and based on whether the user speech contains positive or negative information of a predetermined type, respectively, wherein a result of understanding indicating at least whether or not the most recently input user speech contains the information of the predetermined type, or whether the most recently input user speech contains positive information or negative information of the predetermined type is acquired, and a speech that is based on a speech template corresponding to the result of understanding, of the speech templates, is generated,
wherein the speech is presented.

21. The dialogue device according to claim 8, the circuit further configured to execute a method comprising:
presenting a speech for asking a question about a target element that has a finite number of options; and
accepting a user speech responding to the speech,
wherein a speech is presented based on a difference or sameness between one of options corresponding to the target element contained in the user speech, and one of options corresponding to the target element set to the personality of the agent.

22. The dialogue device according to claim 19, the circuit further configured to execute a method comprising:
wherein at least one speech template of speech templates stored in advance for states of a dialogue scenario is written using element types,
information regarding the element types is stored in advance separately from the templates, and
a speech is generated by inserting information regarding the elements stored in advance separately from the speech templates, into a type of the element in the speech template corresponding to a current state selected from the dialogue scenario.
